(19) United States
(12) Patent Application Publication
(10) Pub. No.: US 2011/0113837 A1
(43) Pub. Date: May 19, 2011

(54) LOCKING DEVICE

(75) Inventors: Pascal-Marie Paul Marcel Soulier, Le Havre (FR); Aurélie De Sorbay, Le Havre (FR)

(73) Assignee: AIRCELLE, GONFREVILLE L'ORCHER (FR)

(21) Appl. No.: 12/673,881

(22) PCT Filed: Aug. 7, 2008
(86) PCT No.: PCT/EP08/60413

§ 371 Date: Feb. 17, 2010

(30) Foreign Application Priority Data
Aug. 20, 2007 (FR) 07/05934

(51) Int. Cl. B60R 25/00; E05B 63/14

(52) U.S. Cl. 70/237; 70/263

(57) ABSTRACT

The invention relates to a locking device (5, 6) comprising a first locking system (7) equipped with a control handle (12), intended to be actuated by an operator, characterized in that it includes a second locking system (8) connected to the first (7) by linking means (9) designed to actuate the second locking system (8) because of the actuation of the first (7), the first locking system (7) being actuated alternately between a locked state and an unlocked state by movement of the handle (12) over the totality of a defined course, the linking means (9) having sequencing means designed to actuate the second locking system (8), between a locked state and an unlocked state thereof respectively, during the displacement of the handle (12) over only part of the travel of the latter.

### TECHNICAL FIELD

A locking device is used in particular in order to be fitted to a nacelle, itself designed to be fitted to an aircraft.

### BACKGROUND

A nacelle is a streamlining element making it possible to protect a jet engine of an aircraft. A nacelle usually comprises two elements articulated on the pylon of the aircraft so as to allow access to the engine housed inside the nacelle, particularly during maintenance operations.

Conventionally, a nacelle comprises at least a first and a second locking device, comprising respectively a first and a second locking system, fitted with a first and a second control handle, designed to be actuated by an operator.

The first locking system is designed to lock the nacelle in the junction zone placed in the bottom portion, that is to say at 6 o'clock, while the second locking system is designed to achieve the locking in the junction zone placed in the top portion, that is to say at 12 o'clock.

The handles are both placed in the bottom portion of the nacelle, for reasons of accessibility.

The use of such locking devices has the drawbacks explained below.

When the nacelle is opened, the two elements are articulated about shafts situated in the top portion, the elements being subjected to the action of cylinders.

The first locking system situated in the bottom portion is capable of preventing an accidental opening of the nacelle when the latter is locked. Specifically, the first locking system is situated at a distance from the articulation shafts of the two elements of the nacelle and the force exerted by the cylinders is not sufficient to cause damage to the first locking system or to the nacelle.

Conversely, if only the second locking system situated in the top portion of the nacelle is locked, the latter is not capable of withstanding the force exerted by the cylinders, unless a particular and constraining design of the structure of the nacelle is provided. In this case, the second locking system, or even the articulated elements of the nacelle, can be greatly damaged.

In addition, the operator is forced to actuate two handles in order to unlock or lock the aforementioned locking devices, which is awkward and easily gives rise to operating errors, the consequences of which are in particular explained above.

The risk of such an operating error is all the greater if the operator does not see the second locking system placed in the top portion of the nacelle. The closure of the latter is therefore carried out “blind”.

Finally, other drawbacks are the complexity, the weight and the space requirement of the two locking devices.

### BRIEF SUMMARY

The invention relates to a locking device comprising a first locking system fitted with a control handle, designed to be actuated by an operator, characterized in that it comprises a second locking system, connected to the first by linking means arranged to actuate the second locking system via the actuation of the first, the first locking system being actuated alternately between a locked state and an unlocked state by the displacement of the handle over the whole of a determined travel, the linking means comprising sequencing means arranged to actuate the second locking system, respectively between a locked state and an unlocked state of the latter, when the handle is moved over only a portion of the travel of the latter.

In this manner, when the locking device is opened with the aid of the handle, the second locking system is unlocked or “opened” before the first. Therefore, when the first locking system is completely unlocked, the operator is certain that the second locking system is as well.

Similarly, when the locking device is closed, the second locking system is locked or “closed” before the first. Therefore, when the first locking system is completely locked, the operator is certain that the second locking system is as well.

Therefore, in an example of application to a nacelle, the first locking system is advantageously that placed at 6 o'clock, the second being that placed at 12 o'clock.

The sequencing between the actuation of the two locking systems also makes it possible to compensate for the adjustment and regulation tolerances of the linking means. Specifically, if it was envisaged to simultaneously control the two locking systems with the aid of the handle, that would require precise regulation and adjustment of the linking means between the two locking systems, which is particularly difficult with movable elements that are a distance apart. This also becomes very constraining with elements subjected to high temperature differences because of the effects of expansion of the materials and of the large dimensions of the elements. If the two locking systems are not controlled in an exactly simultaneous manner, the aforementioned risk of damage still remains when the nacelle is accidentally opened.

Finally, in the absence of sequencing, and in the event of poor regulation, the operator forces the whole line of control which has to be sized accordingly.

The sequencing therefore makes it possible to dispense with a precise regulation of the linking means, making the device safer and less costly in manufacturing and maintenance terms.

Advantageously, the sequencing means comprise a cam comprising a track interacting with a follower element moving along the latter, the track comprising an active portion and a passive portion so that the transformation of the pivoting movement of the cam into a displacement movement of the follower element, or vice versa, takes place over only the active portion of the track.

In this manner, when the handle is actuated, the follower element first moves over the passive portion so that the second locking system is not actuated. The follower element then reaches the active portion of the track and moves along this portion. The second locking system is then actuated along the whole displacement of the follower element over the active portion and moves from a locked state to an unlocked state, or vice versa. When the follower element has travelled over the active portion of the track, it then again reaches the passive portion and moves along the latter so that the second locking system is no longer actuated.

According to one feature of the invention, the linking means comprise a movable transmission member, comprising a first end connected to the first locking system and a second end connected to the cam, the actuation of the first locking system causing the translation by traction or compression of the transmission member.

According to one embodiment of the invention, the follower element is placed at the second end of the transmission member, the displacement of the follower element over the active portion of the track causing the pivoting of the cam, the second locking system comprising a bolt connected to the cam, actuated by the pivoting of the latter.

Therefore, the cam pivots only when the follower element is displaced along the active portion of the track, causing with it the displacement of the bolt. The cam therefore makes it possible to transform the displacement movement of the follower element into a movement of rotation of the cam and of displacement of the bolt.

Preferably, the bolt can be moved in translation and is fitted with a finger inserted into an oblong hole arranged in the cam.

The oblong hole makes it possible to compensate for the differences of trajectory between the linking zone of the cam with the bolt and the trajectory of the bolt. Specifically, the aforementioned linking zone moves on a curvilinear trajectory the center of which is the center of rotation of the cam while the bolt moves in a rectilinear manner.

According to another embodiment of the invention, the cam is arranged in order to pivot over a determined travel when the handle is displaced, the cam interacting with the second locking system so as to achieve its actuation over only a portion of the total travel of the cam.

Advantageously, the second end of the transmission member is connected to the cam so that the displacement of the transmission member rotates the cam, the second locking system comprising a bolt comprising the follower element, the pivoting of the cam causing the displacement of the follower element and of the bolt when the follower element is displaced over the active portion of the track.

The cam therefore makes it possible to transform the rotary movement of the cam into a displacement movement of the follower element and of the bolt, when the follower element reaches the active portion of the track.

According to one feature of the invention, the cam is mounted on the second locking system.

The invention also relates to a nacelle comprising at least one locking device according to the invention.

The invention also relates to an aircraft fitted with at least one nacelle according to the invention.

### BRIEF DESCRIPTION OF THE DRAWINGS

In any case, the invention will be well understood with the aid of the following description with reference to the appended schematic drawing representing, as examples, several embodiments of this locking device.

FIG. 1 is an exploded schematic view, in perspective, of the nacelle fitted with locking devices according to the invention.

FIGS. 2 to 9 are views illustrating a first embodiment of the device, in which

FIG. 2 is a front view of the second locking system in a first position;

FIG. 3 is a front view of the first locking device, in the first position;

FIGS. 4-5, 6-7 and 8-9 are views corresponding to FIGS. 2-3, respectively in three successive positions of the locking device;

FIGS. 10 to 19 are views illustrating a second embodiment of the device, in which

FIGS. 10 and 11 are views corresponding to FIGS. 2 and 3;

FIGS. 12-13, 14-15, 16-17 and 18-19 are views corresponding to FIGS. 10-11, respectively in four successive positions of the locking device;

FIGS. 20-29 are views illustrating a third embodiment of the device, corresponding respectively to FIGS. 10 to 19.

### DETAILED DESCRIPTION

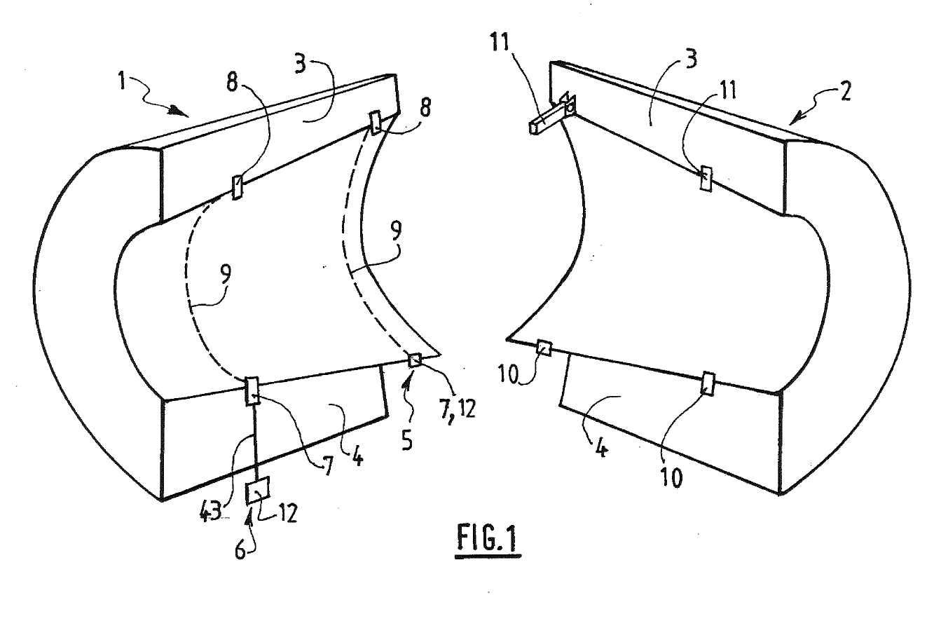

FIG. 1 represents an exploded view of the rear section of a nacelle. The latter comprises, as is known to those skilled in the art, a first and second movable elements 1, 2, articulated at their top portion on a pylon of an aircraft, not shown.

Each articulated element 1, 2 takes the general form of a hollow half-cylinder, delimiting two junction zones 3, 4 with the articulated element facing it, namely a top junction zone 3 and a bottom junction zone 4.

The bottom and top positions are also called respectively the 6 o′clock and 12 o′clock positions.

The nacelle is fitted with a first and a second locking device 5, 6.

It should be noted that, for reasons of presentation, only two of these devices are shown.

Each locking device 5, 6 comprises a first locking system 7 and a second locking system 8, connected to the first by linking means 9 arranged to actuate the second locking system 8 by the actuation of the first 7.

Each locking system 7, 8 is mounted on the first movable element 1 and is capable of being locked to a corresponding retention member 10, 11, mounted on the second movable element 2.

The first and second locking systems 7, 8 of each locking device 5, 6 are mounted respectively in the bottom and top junction zones 4, 3 of the first articulated element 1.

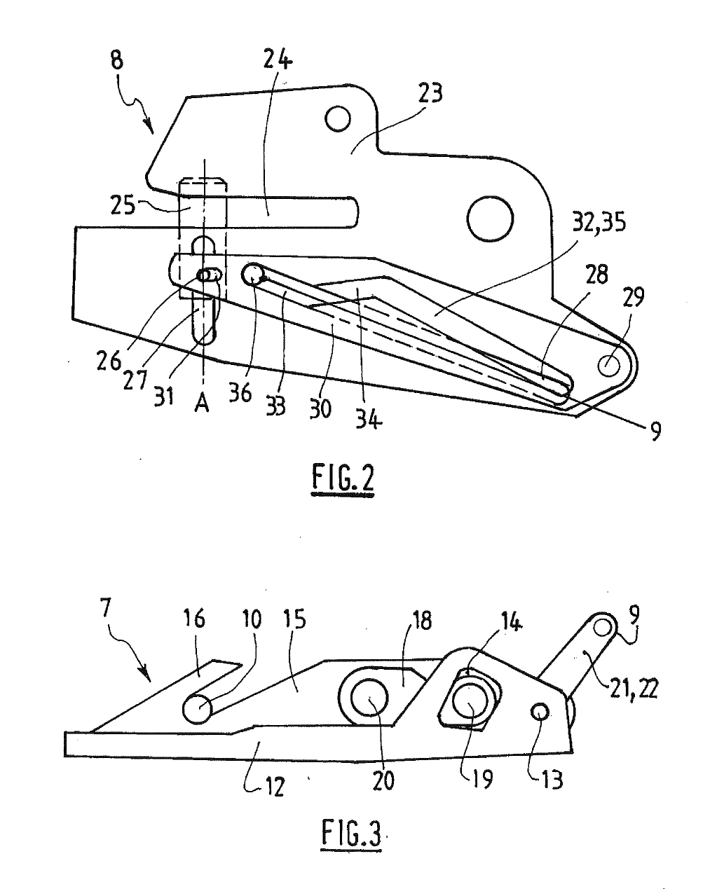

The structure and the operation of the first locking device 5 according to a first embodiment of the invention will now be described in greater detail with reference to FIGS. 2 to 9.8

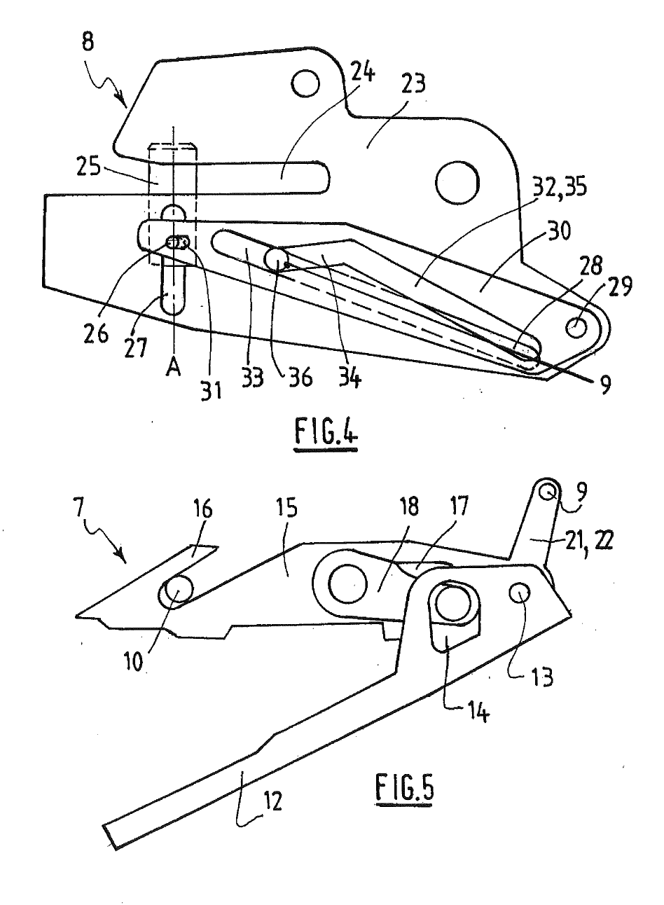

As shown in FIG. 3, the first locking system 7 comprises a control handle 12 designed to be actuated by an operator. The handle 12 is mounted pivotingly on a shaft 13 and comprises an opening 14. The first locking system 7 also comprises an element 15 having a hook 16 close to a first end and mounted pivotingly at a second end on the shaft 13. This element 15 also has an oblong opening 17 in its middle portion, as can be seen more particularly in FIG. 7. The hook 16 is designed to engage with the retention member 10 of the second articulated element 2 of the nacelle.

The first locking system 7 also comprises a link rod 18 articulated at a first and a second end about a first and a second shaft 19, 20 protruding respectively into the opening 14 of the handle 12 and into the oblong opening 17 of the element 15 having the hook 16. The shafts 19, 20 can be moved inside each of the openings 14, 17. In addition, the second shaft 20 is fixed relative to the first articulated element 1 of the nacelle.

The first locking system 7 also comprises a movement-transformation member 21 mounted pivotingly on the shaft 13 and articulated on the first shaft 19 of the link rod 18. The movement-transformation member 21 also comprises an arm 22. The linking means comprise a flexible cable 9 symbolized by a line for reasons of clarity of the drawing. The cable 9 has a first and a second end, the first end being mounted articulated on the free end of the arm 21.

As shown in FIG. 2, the second locking system 8 comprises a body 23 that is fixed relative to the first articulated element 1 of the nacelle.

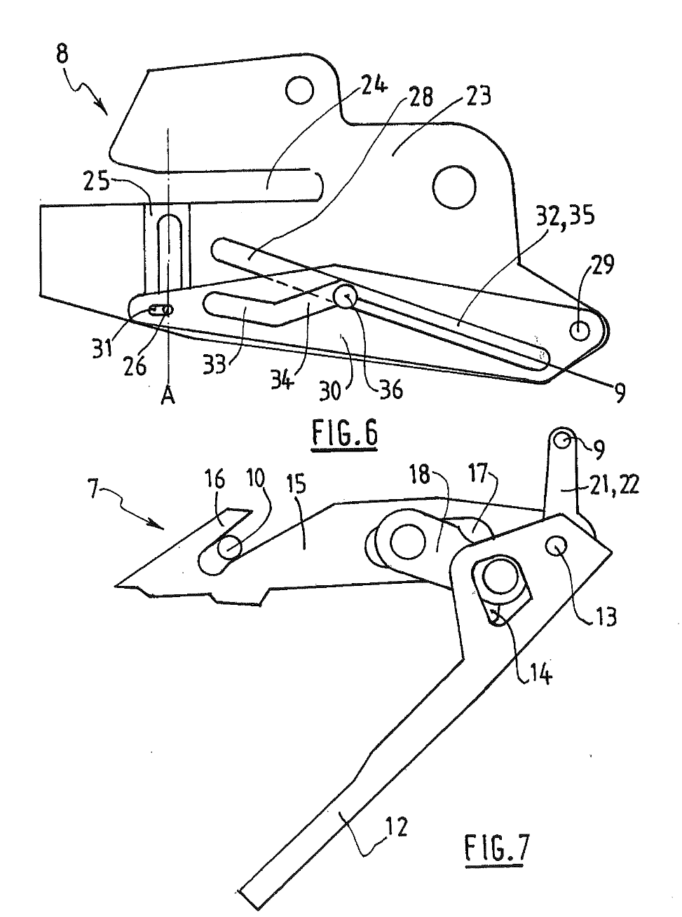

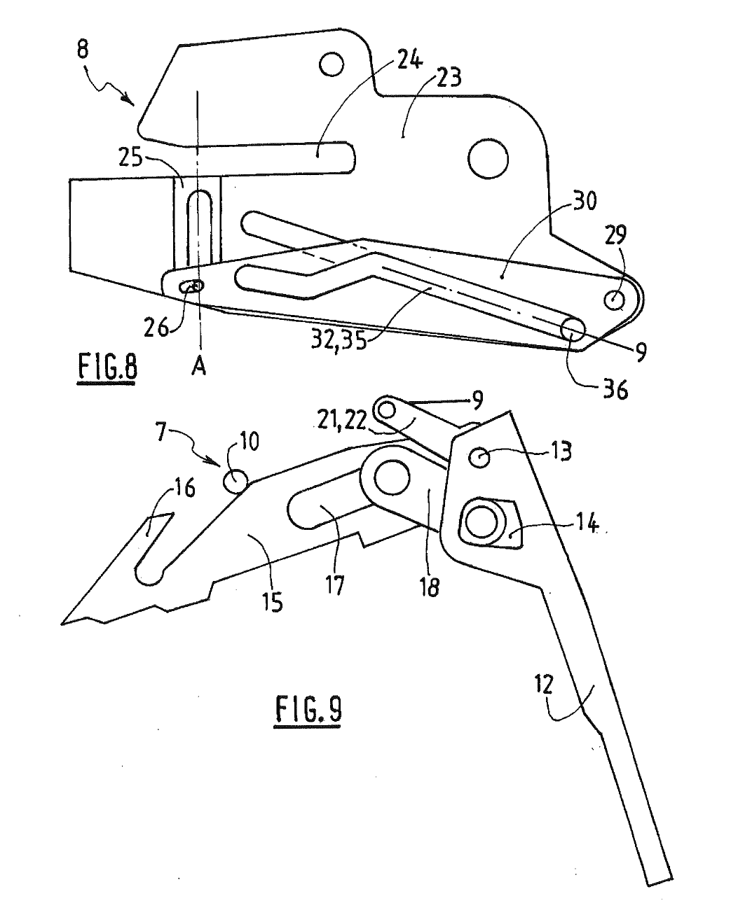

The body 23 comprises a slot 24 allowing the insertion of the corresponding retention member 11, a bolt 25 being mounted movably in translation on the body, along an axis A perpendicular to the slot 24, between a locked position in which the bolt 25 passes through the slot 24 or protrudes into the latter, as shown in FIG. 2, and an unlocked position in which the bolt 25 is fully housed inside the body 23 and does not or virtually does not protrude into the slot 24, shown in FIGS. 6 and 8.

The bolt 25 comprises a post 26 protruding perpendicularly to the axis A and to the slot 24, through an oblong opening 27 arranged in the body 23 along the axis A so as to allow the displacement of the bolt 25.

The body 23 also comprises an oblong opening or a groove 28 extending obliquely relative to the slot 24 and to the oblong opening 27, between a first end situated in the vicinity of the slot 24 and of the oblong opening 27 and a second end situated in the vicinity of an articulation shaft 29 the function of which is described below.

The locking device also comprises sequencing means comprising a cam 30 of elongated shape, comprising a first and a second end. The cam 30 is mounted pivotingly at its first end on the body 23 of the second locking system 8, about the shaft 29. The cam 30 also comprises an oblong hole 31 at its second end, the post 26 of the bolt 25 protruding into the oblong hole so that the latter extends substantially perpendicularly to the axis A of displacement of the bolt 25.

The cam 30 also comprises a track 32 formed by an oblong opening in the general shape of a staircase step. The track 32 therefore has three successive portions, namely a first passive portion 33, a second active portion 34 and a third passive portion 35, the function of which is given in detail below.

The cable 9, shown schematically by a line, comprises a finger 36 at its second end, the finger 36 being inserted into the track 32 of the cam 30 and into the groove 28 of the body 23 so as to form a follower element.

Described below are the successive steps for opening the locking device, illustrated in FIGS. 2 to 9.

FIGS. 2 and 3 represent the locked position of the latter, in which the first and second locking systems 7, 8 are both locked. In this position, the handle 12 is in the closed position, that is to say brought closer to the element 15 having the hook 16, the follower finger 36 being situated in the first passive portion 33 of the track 32, at the end of the track. The cam 30 is placed in a first angular position in which the bolt 25 which is connected to it is in the top position, that is to say passes through the slot 24.

As shown in FIGS. 4 and 5, when the user actuates the handle 12 in order to open it, the arm 22 pivots in the counterclockwise direction in order to displace the cable 9 in translation, by pulling on the latter. The follower finger 36 is then displaced along the first passive portion 33 of the track 32. During this displacement, the cam 30 does not pivot, the first passive portion 33 of the track 32 coinciding then with the groove 28 arranged in the body 23.

When the operator continues to actuate the handle 12, the first shaft 19 of the link rod 18 butts against the edge of the opening 14 of the handle 12 and is operated by the movement of the latter. The link rod 18 is then displaced so that the second shaft 20 of the latter translates in the oblong opening 17 of the element 15 comprising the hook 16.

The aforementioned second shaft 20 being fixed, the element 15 comprising the hook 16 is displaced so that the retention element 10 begins to disengage from the hook 16. In this position, the first locking system 7 is still locked since the retention element 10 is not completely disengaged from the hook 16.

Continuing the opening movement of the handle, the arm 22 continues to translate the cable 9 so that the follower finger 36 is displaced along the second active portion 34 of the track 32, from one end to the other of the latter. As seen above, the second active portion 34 is oriented obliquely relative to the first passive portion 33 and the follower finger 36 is inserted into the groove 28 of the fixed body 23. The cam 30 is therefore rotated in the counterclockwise direction about the shaft 29 and displaces the bolt 25 in the bottom position. During this displacement, the post 26 of the bolt 25 translates in the oblong hole 31 of the cam 30, which makes it possible to compensate for the differences in trajectories between the curvilinear trajectory of the end of the cam 30 attached to the bolt 25 and the rectilinear trajectory A of the latter.

As shown in FIG. 6, the bolt 25 is disengaged from the slot 24 when the follower finger 36 has traversed the active portion 34 of the track 32. Therefore, the second locking system 8 is unlocked even when the first 7 is still locked, because the retention member 10 is still engaged in the hook 16.

As shown in FIGS. 8 and 9, when the operator continues to actuate the handle 12, the retention element 10 is completely disengaged from the hook 16 so that the first locking system 7 is unlocked. As above, the arm 22 continues to translate the cable 9 so that the follower finger 36 is displaced along the third passive portion 35 of the track 32. This passive portion 35 then extends along the axis of the groove 28 of the body 23 so that the displacement of the follower finger 36 does not cause the pivoting of the cam 30. Consequently, the bolt 25 is not displaced.

Therefore, as described above, the first locking device is sequenced. Specifically, when the handle 12 is opened, the operator first unlocks the second locking system 8, then the first locking system 7. This prevents the operating errors explained in the introduction part.

It will be easy to understand that, when the handle 12 is closed, the operator first locks the first locking system 7 and then locks the second locking system 8.

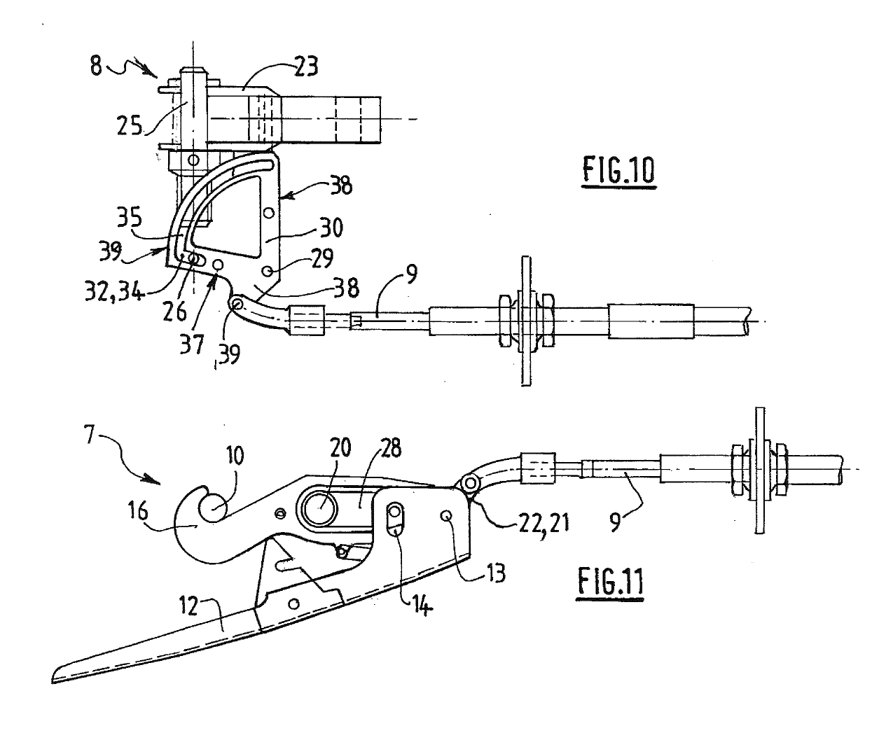

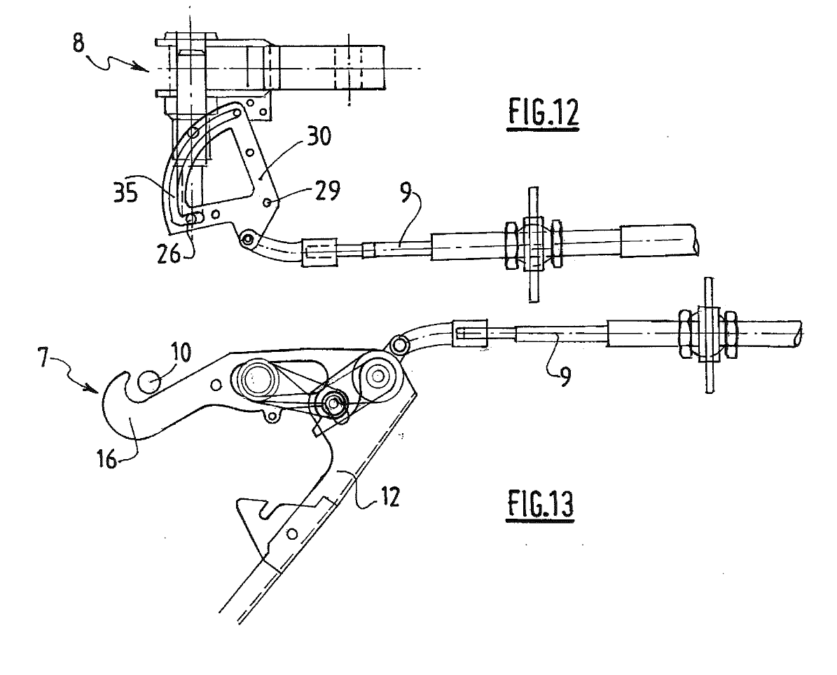

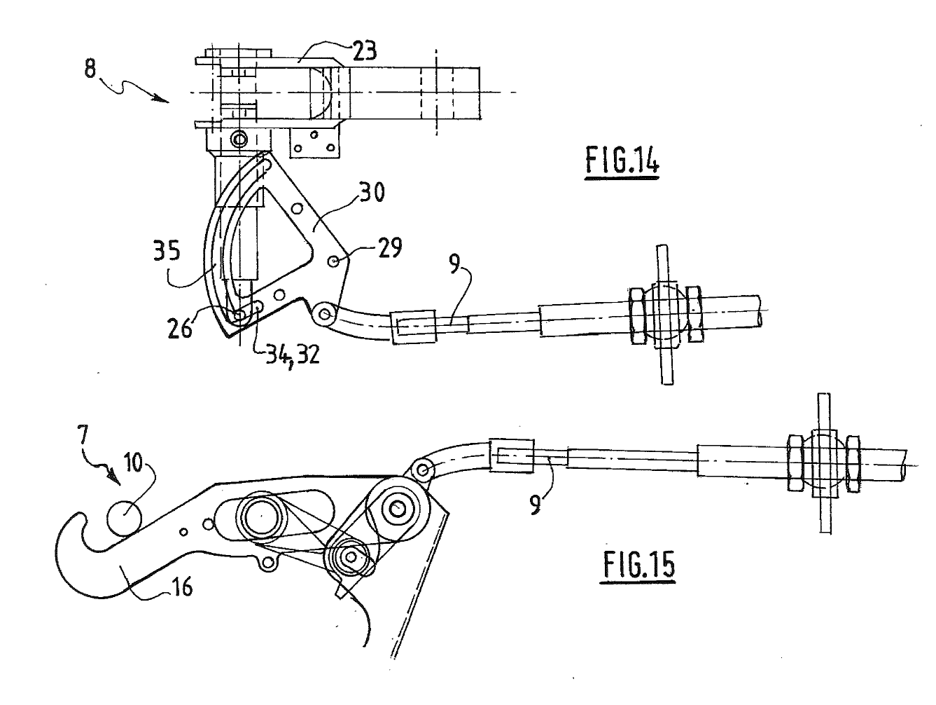

FIGS. 10 to 19 illustrate a second embodiment also corresponding to the first locking device the position of which in the nacelle is shown in FIG. 1.

To make it easier to understand, the elements have been designated by the same reference numbers as before.

As appears in FIG. 11, the first locking system has a structure similar to that illustrated in FIG. 3.

The second locking system is shown in FIG. 10. As before, the bolt 25 is mounted so as to be able to be displaced in the body 23, the post 26 protruding outward from the bolt 25. In addition, the cam 30 is also mounted pivotingly about the shaft 29.

In this embodiment, the cam 30 has a general shape of a quarter of a disk, comprising a first and a second adjacent edge 37, 38 substantially forming a right angle relative to one another, connected via a peripheral edge 39 in the arc of a circle.

The cam 30 is mounted pivotingly close to the right-angle zone.

The first edge 37 comprises, close to the right-angle zone, a lug 38 protruding outward, the free end of which is connected via an articulation shaft 39 to the second end of the cable 9.

Consequently, the displacement of the cable 9 causes the cam 30 to pivot about the shaft 29.

As before, the cam 30 comprises a track 32 in the form of an opening, having an active portion 34 and a passive portion 35.

The passive portion 35 of the track 32 extends in a parallel arc of a circle set back from the peripheral edge 39 of the cam 30 and of which the center corresponds to the shaft 29. The active portion 34 of the track 32 extends substantially parallel to the first edge 37 of the cam 30, from the passive portion 35 so as to form a continuous track.

The post 26 of the bolt 25 is inserted into the track 32 and thus forms a follower element.

As is shown successively in FIGS. 10 to 15, the opening of the handle 12 by the operator makes it possible to exert traction on the cable 9 via the arm so that the cable 9 rotates the cam 30 in the counterclockwise direction. During this rotation, the post 26 of the bolt 25 is displaced along the active portion 34, translating the bolt 25 downward so as to open the second locking system 8.

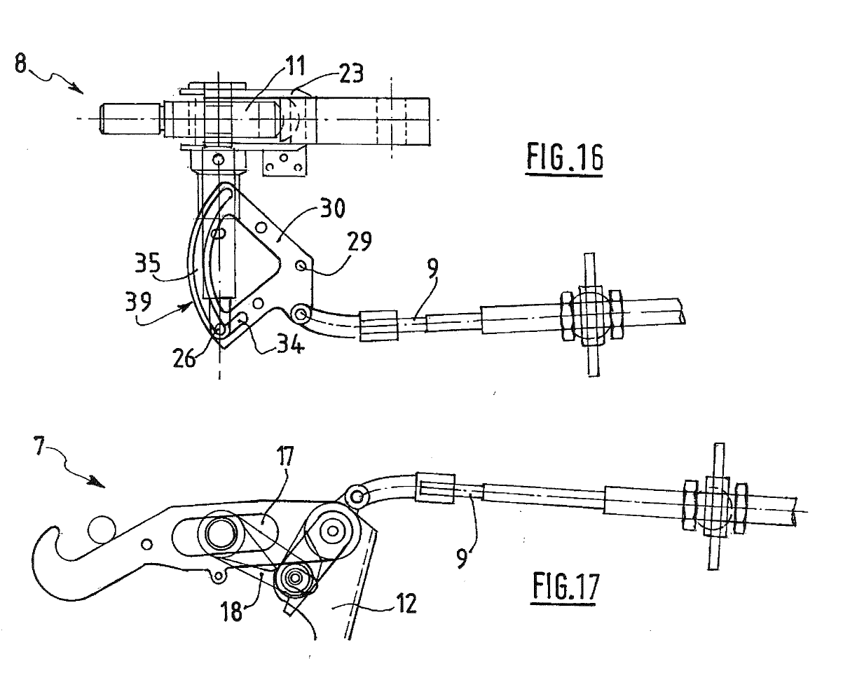

FIG. 16 represents the second locking system 8 in the completely unlocked position in which the follower post 26, having traversed all of the active portion 34 of the track, enters the passive portion 35. It is then possible to engage or disengage the retention member 11 fixed to the second movable portion 2 of the nacelle.

From this position, when the operator continues to open the handle 12 and consequently to pivot the cam 30, the follower post 26 is displaced in the passive portion 35 of the track 32. This displacement does not cause the displacement of the bolt 25.

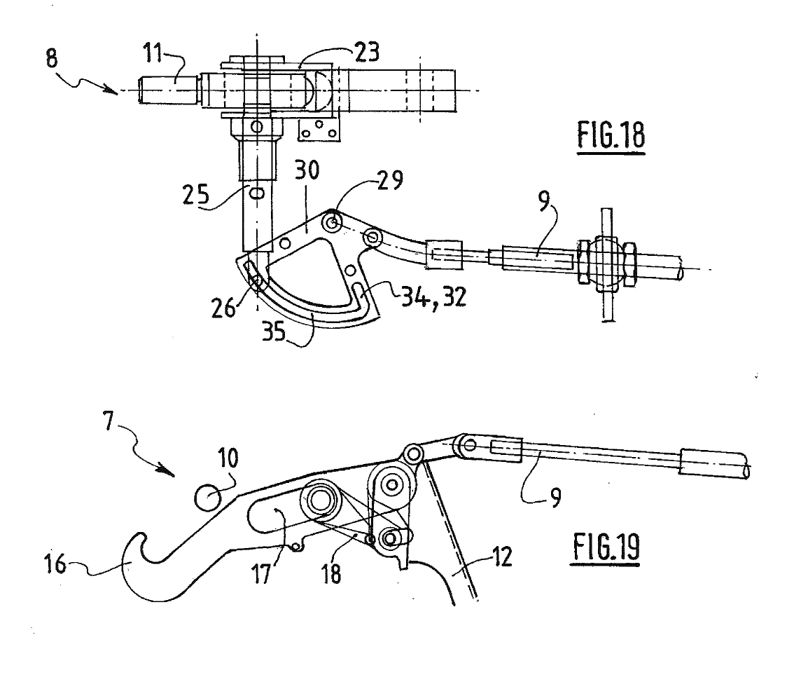

As above, when the handle is displaced over the whole of its travel, as shown in FIGS. 18 and 19, the hook 16 is completely disengaged from the corresponding retention element 10 so as to unlock the first locking system 7.

This second embodiment therefore also allows sequencing between the actuation of the first and of the second locking system 7, 8 so that, when the handle 12 is opened, the operator first unlocks the second locking system 8 and then unlocks the first locking system 7.

As above, the locking of this device is obtained by the inverse succession of the aforementioned steps.

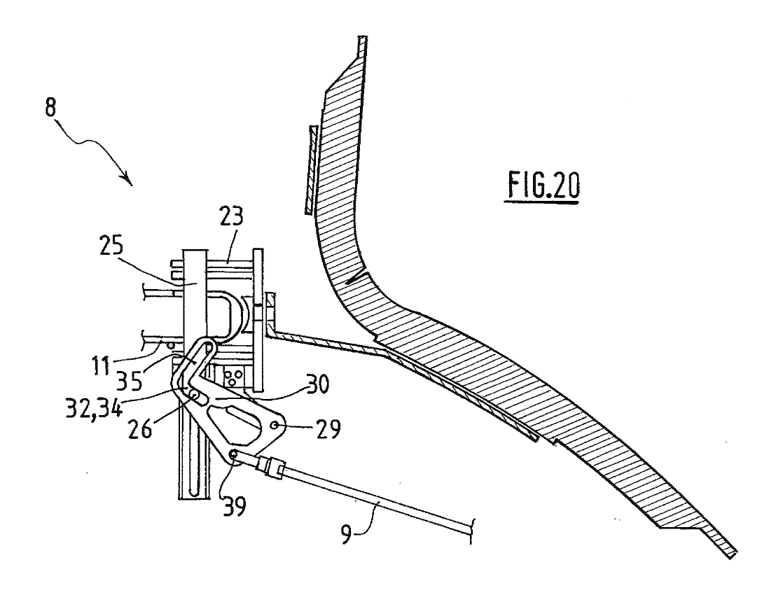

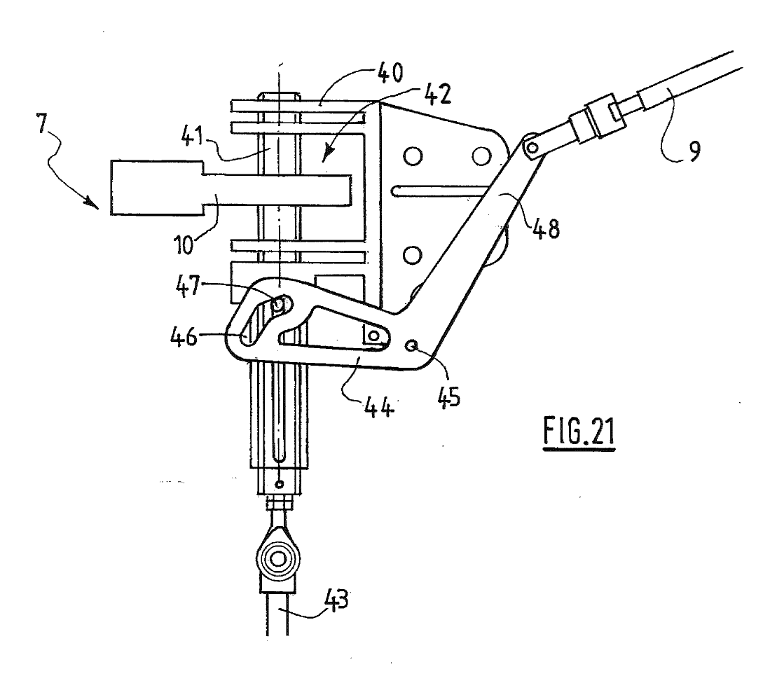

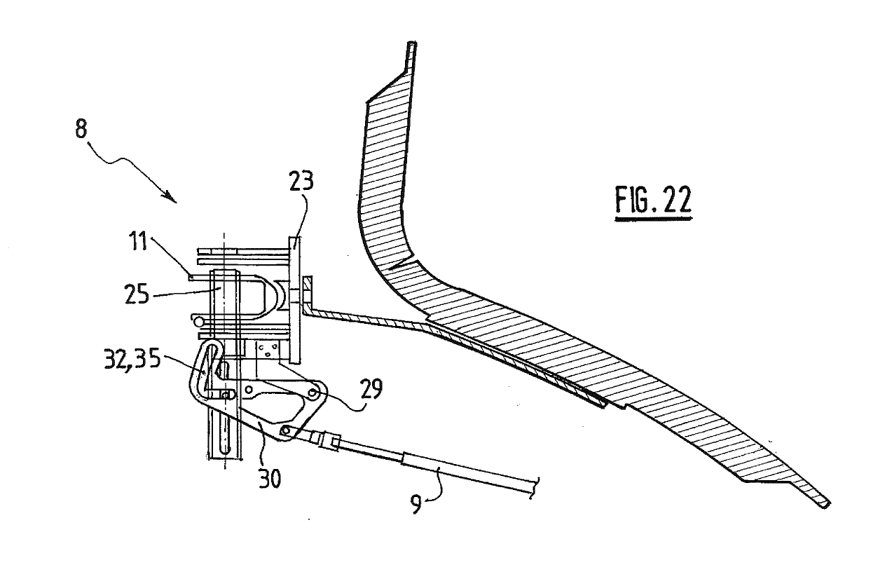

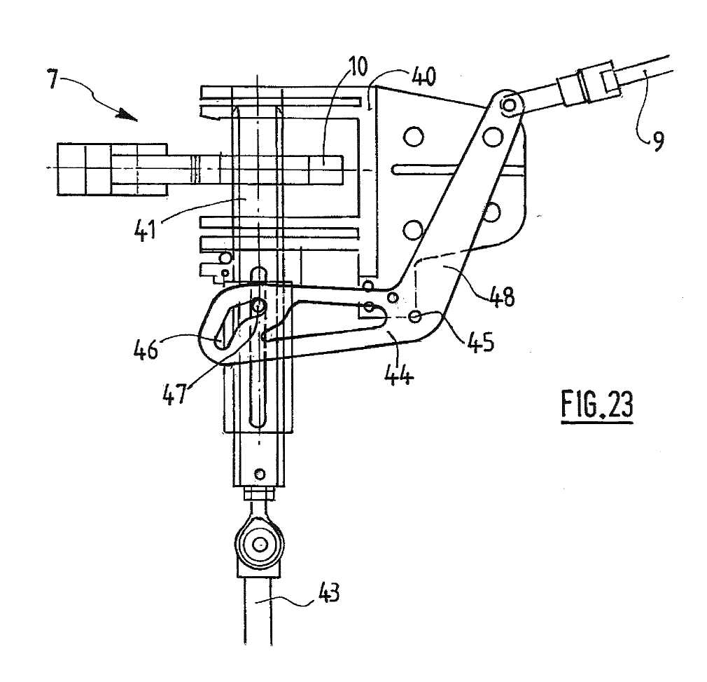

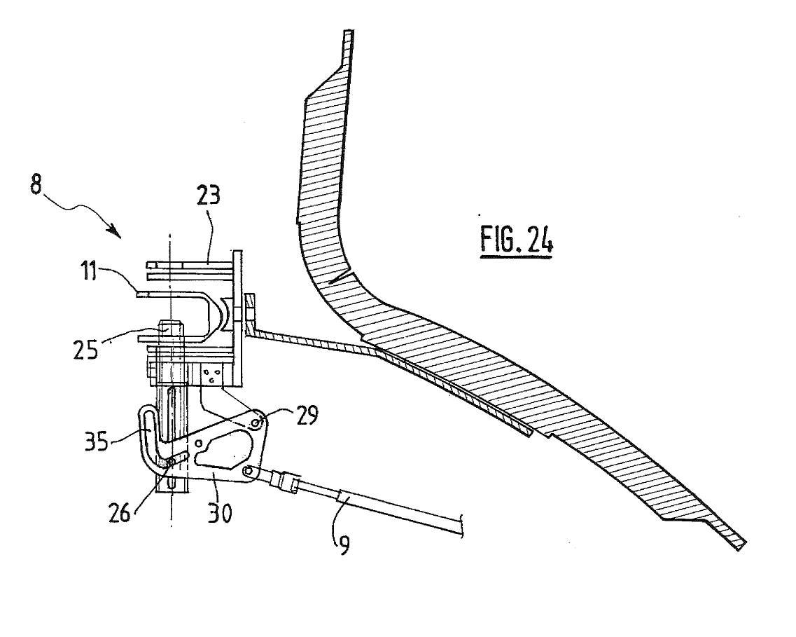

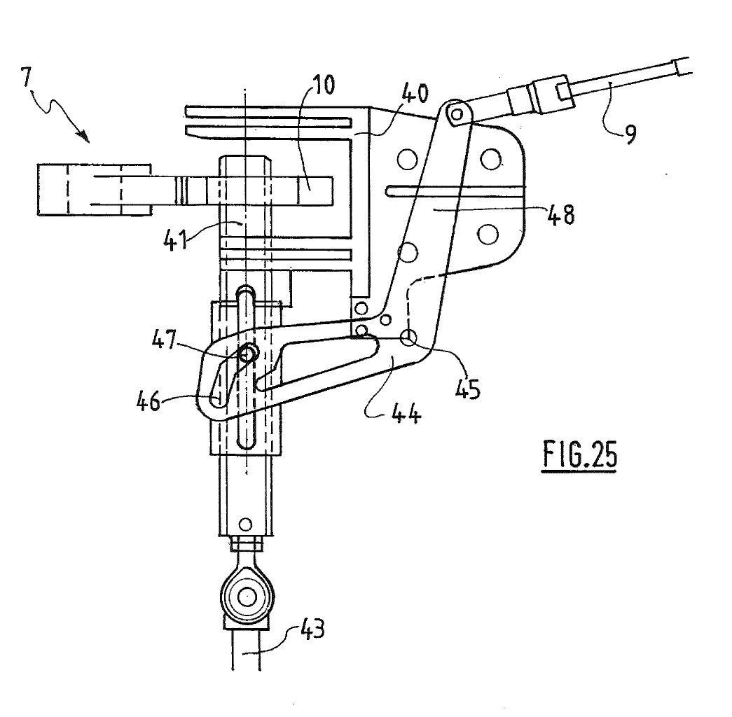

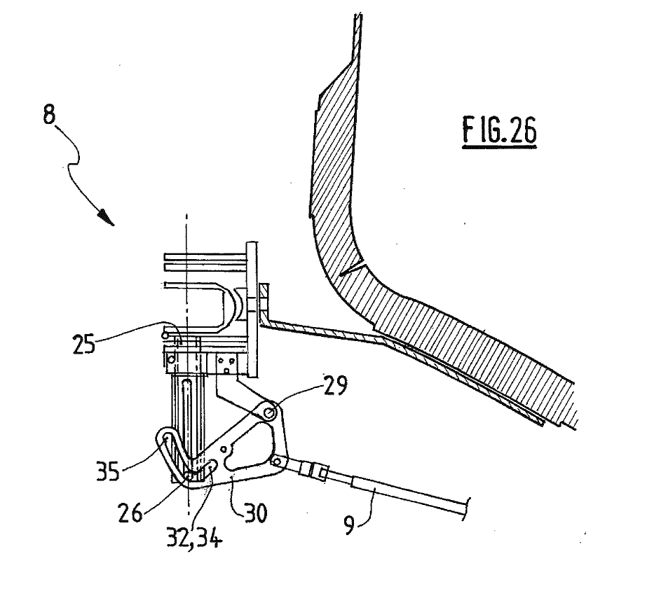

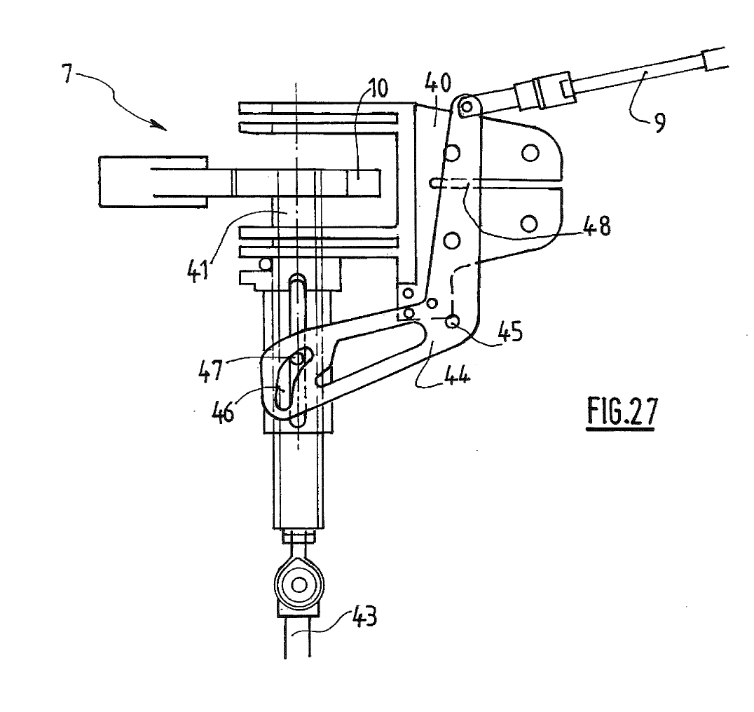

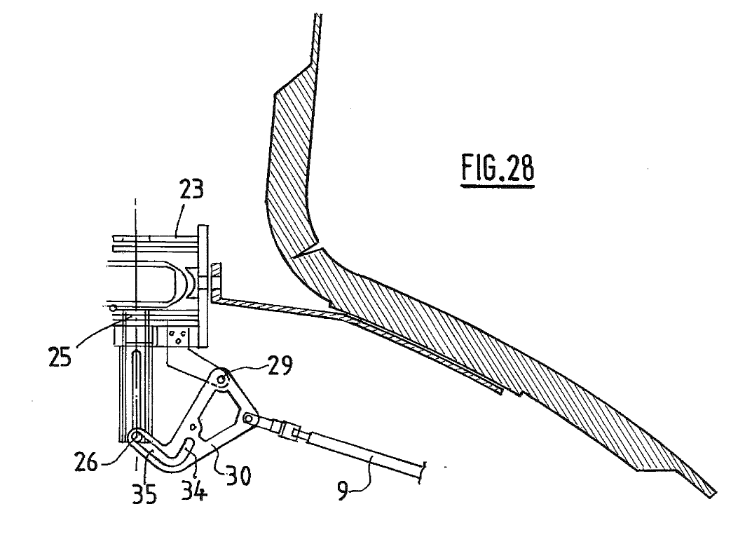

A third embodiment is illustrated in FIGS. 20 to 29. This third embodiment corresponds to the second locking device 6 the position of which is illustrated in FIG. 1. For easier understanding, the elements have been designated by the same reference numbers as before.

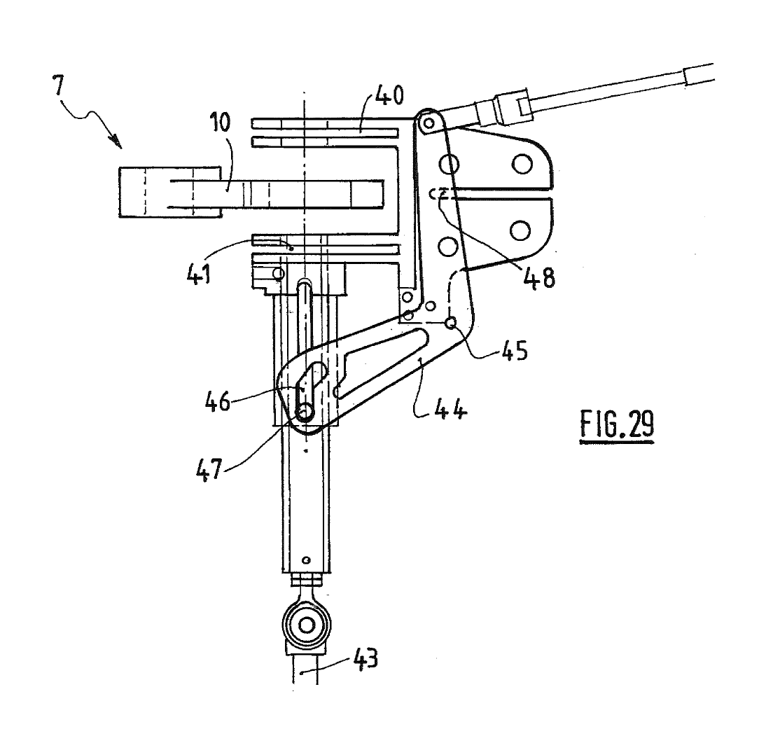

The first locking system 7 is shown in FIG. 21. The latter comprises a body 40 that is fixed relative to the movable element 1 and is fitted with a bolt 41 mounted so as to be displaceable in translation on the body, capable of being displaced between a first locked position shown in FIG. 21 in which the bolt 41 traverses a slot 42 designed for the insertion of the corresponding retention member 10, and an unlocked position shown in FIG. 29 in which the bolt 41 is retracted relative to the slot 42.

The translation of the bolt 41 is actuated by the user, via a handle 12, shown in FIG. 1, connected to the bolt 41 by a rod 43.

The second locking device 6 also comprises a movement-transformation member 44, mounted on the first locking system 7, making it possible to transform the translation movement of the handle 12 and of the bolt into a translation movement by traction or compression of the cable 9.

The movement-transformation element 44 is of elongated shape, comprises a first end mounted pivotingly on the body 40 of the first locking system, about a shaft 45, and comprises a second end at which an opening 46 is arranged. According to one embodiment, the opening 46 comprises a passive portion and an active portion.

In addition, the bolt 41 comprises a follower post 47 protruding into the opening 46.

The movement-transformation element 44 also has an arm 48 protruding outward at the first end, the free end of the arm being connected to the first end of the cable 9.

The second locking system 8 is illustrated in FIG. 20. In this embodiment, the cam 30 is mounted pivotingly about the shaft 29, the second end of the cable 9 being connected to the cam 30 at the shaft 39.

The track 32 of the cam 20 has a shape similar to that of the second embodiment, that is to say comprises a passive portion 35 in the shape of an arc of a circle the center of which corresponds to the pivot shaft 29 of the cam 30, from which a straight active portion 34 extends.

The operation and the movement sequence of the second locking system 8 of this third embodiment of the invention are similar to those of the second embodiment described above.

The operation of the second locking device 6 will now be described below.

When the user pulls on the control handle 12, the bolt is displaced downward, rotating the movement-transformation element 44 in the counterclockwise direction. The latter then translates the cable 9 connected to the cam 30. The latter is therefore rotated in the counterclockwise direction, the follower post 26 of the bolt 25 traversing the active portion 34 of the track 32 so as to displace the bolt 25 downward, that is to say so as to unlock the second locking system 8. The active portion 34 is extended by an overtravel forming an additional passive portion, necessary in order to compensate for the positioning differences between the various components.

This position is shown in FIG. 26. The travel of the bolt 41 of the first locking system 7 and the shape of the opening 46 of the movement-transformation element 44 are arranged so that only a portion of the travel of the handle 12 necessary for completely opening the first locking system 7 is sufficient for the follower post 26 to traverse the active portion 34 of the track 32, that is to say to unlock the second locking system 8.

When the user continues to pull on the handle 12, the bolt 41 continues its translation movement downward until the latter reaches the unlocked position shown in FIG. 29. During this movement of the handle 12, the cam 30 is pivoted so that the follower finger 26 of the bolt 25 of the second locking system 8 is displaced along the passive portion 35 of the track 32, the bolt 25 then not being displaced in translation.

As above, the unlocking of the second locking device is achieved in a sequenced manner, the locking being obtained by the inverse succession of the aforementioned steps.

As it goes without saying, the invention is not solely limited to the embodiments of this locking device that have been described above as examples, but on the contrary it covers all the variants.

1. A locking device comprising:
a first locking system fitted with a control handle, designed to be actuated by an operator,
a second locking system, connected to the first by linking means arranged to actuate the second locking system via the actuation of the first,
wherein the first locking system is actuated alternately between a locked state and an unlocked state by the displacement of the handle over a whole of a determined travel,
wherein the linking means comprises sequencing means arranged to actuate the second locking system, respectively between a locked state and an unlocked state of the latter, when the handle is moved over only a portion of travel of the latter.

2. The device as claimed in claim 1, wherein the sequencing means comprise a cam comprising a track interacting with a follower element moving along the latter, the track comprising an active portion and a passive portion so that the transformation of a pivoting movement of the cam into a displacement movement of the follower element, or vice versa, takes place over only the active portion of the track.

3. The device as claimed in claim 2, wherein the linking means comprise a movable transmission member, comprising a first end connected to the first locking system and a second end connected to the cam, the actuation of the first locking system causing the translation by traction or compression of the transmission member.

4. The device as claimed in claim 3, wherein the follower element is placed at the second end of the transmission member, the displacement of the follower element over the active portion of the track causing the pivoting of the cam, the second locking system comprising a bolt connected to the cam, actuated by the pivoting of the latter.

5. The device as claimed in claim 4, wherein the bolt can be moved in translation and is fitted with a finger inserted into an oblong hole arranged in the cam.

6. The device as claimed in claim 3, wherein the cam is arranged in order to pivot over a determined travel when the handle is displaced, the cam interacting with the second locking system so as to achieve its an actuation over only a portion of the total travel of the cam.

7. The device as claimed in claim 3, wherein the second end of the transmission member is connected to the cam so that the displacement of the transmission member rotates the cam, the second locking system comprising a bolt comprising the follower element, pivoting of the cam causing the displacement of the follower element and of the bolt when the follower element is displaced over the active portion of the track.

8. The device as claimed in claim 2, wherein the cam is mounted on the second locking system.

9. A nacelle, comprising at least one locking device as claimed in claim 1.

10. An aircraft, comprising at least one nacelle as claimed in claim 9.
